(19) United States
(12) Patent Application Publication
(10) Pub. No.: US 2023/0182889 A1
(43) Pub. Date: Jun. 15, 2023

(54) AN ACTUATING MECHANISM

(71) Applicant: TUSAS- TURK HAVACILIK VE UZAY SANAYII ANONIM SIRKETI, Ankara (TR)

(72) Inventor: Fahri Bugra CAMLICA, Ankara (TR)

(21) Appl. No.: 18/015,833

(22) PCT Filed: Apr. 15, 2021
(86) PCT No.: PCT/TR2021/050355

§ 371 Date: Jan. 12, 2023

(30) Foreign Application Priority Data
Jul. 23, 2020 (TR) 2020/11720

(51) Int. Cl. B64C 13/50

(52) U.S. Cl. CPC B64C 13/50

(57) ABSTRACT

An actuating mechanism is disclosed for a body in an air and/or space vehicle. having at least one control surface on the body for moving relative to the body and thereby enabling control of the air flow and enabling the air vehicle to maneuver. The actuating mechanism has at least two actuators produced from an electro-active polymer material between the body and the control surface for changing its form depending on electrical energy and thereby triggering the control surfaced.

This invention relates to an actuating mechanism developed to enable moving control surfaces on air vehicles to move.

The movements of an air and/or space vehicle are carried out by moving control surfaces. Moving control surfaces such as elevator, rudder, aileron, flap, etc. with hinges and/or relative mobility are moved by sources such as electric motors, hydraulic power generators.

Dielectric elastomer actuators (DEA), one type of actuators that can be used to move the control surfaces in air and/or space vehicles, work based on the principle of converting electrical energy into mechanical energy. Dielectric elastomer actuators are preferred due to their lightness, flexibility, low energy requirement and low production costs. When these actuators are produced in the form of a strip, a motion output can be obtained by making use of their ability to make an elongation motion on a predetermined axis as they are triggered with electrical energy.

The Chinese patent document CN109533279A, which is included in the known state of the art, makes mention on an embodiment using dielectric elastomers for the rotation of fins in air vehicles. In said embodiment, a fin is connected to a main wing by means of joints and is enabled to rotate on the axis of these joints. It is disclosed that there are elastomers on the fin and main wing and that energy applied to these elastomers enables the fin to rotate on the axis of said joints.

Thanks to the actuating mechanism developed by the present invention, the actuation of moving control surfaces in air and/or space vehicles can be realized by means of a more lightweight actuating mechanism.

A further object of this invention is to realize the movement of the control surfaces in a more efficient and reliable manner by a simpler mechanism.

A further object of the present invention is to provide a more noiseless mechanism as compared to the motor systems used in the known state of art for moving the control surfaces.

The actuating mechanism realized to achieve the object of the invention, defined in the first claim and in the claims dependent on thereon, comprises a body in an air and/or space vehicle, at least one control surface located on the body, enabling air flow to be controlled and the air vehicle to perform a desired movement by performing a movement relative to the body, at least two actuators produced from an electro-active polymer material between the body and the control surface, changing their form depending on electrical energy and thereby driving the control surface. The ability to perform a desired movement in the air and/or space vehicle is provided by control surfaces. Control surfaces move with the energy supplied by the actuator(s).

The actuating mechanism of the invention comprises a connection element located between the actuators such that it can move depending on the movement of the actuators and connecting the actuators to each other, a transmission element moved by means of the connection element, thereby enabling the control surface to move, a bearing which is located on the body, in which the transmission element is located in a movable manner, and which has a form that is predetermined by its manufacturer. The ends of the two actuators that are not connected to the body are connected to each other by the connection element. The connection element is coaxially or asymmetrically connected to the transmission element. One end of the control surface is connected to the transmission element. The movement between the two actuators is transferred to the transmission element, the transmission element moves in a slidable manner in the bearing, thus allowing the control surface connected to it to move. The actuators can be connected with different angles so that the wing movements can be more easily simulated based on parameters such as the location used and the wing geometry.

In an embodiment of the invention, the actuating mechanism comprises at least one wing located on the body, extending outward from the body and enabling the air and/or space vehicle to rise depending on the air flow, and a control surface located on the wing. The movements of the control surface on the wing are provided by the actuating mechanism of the invention.

In an embodiment of the invention, the actuating mechanism comprises a transmission element in a spherical form. The transmission element may be in the form of a ball that slides and/or rolls in the bearing.

In an embodiment of the invention, the actuating mechanism comprises a bearing with an inclined form. The bearing, in which the ball shaped transmission element can be easily rolled, can be flat, rounded, curved, or in a S form, C form, U form.

In an embodiment of the invention, the actuating mechanism comprises a transmission element that is directly connected to the connection element and moves within the bearing with the connection element during the movement of the actuators. The actuators are connected directly to the ball shaped transmission element moving in the bearing and the movement of the ball shaped transmission element ensures the direct movement of the control surface without an intermediary element. In this actuating mechanism with an asymmetrical axis, higher force values emerge compared to an coaxial case and this actuating mechanism can be used in positions requiring high force values in an air and/or space vehicle.

In an embodiment of the invention, the actuating mechanism comprises actuators that are linear and coaxial to each other. Linear and coaxial actuators are connected to each other by the connection element. When one of the actuators is electrically energized, the actuator energized with electricity elongates and accordingly the other actuator shortens itself. Thus, the connection element moves. The connection element triggers the transmission element. The movement of the transmission element, in turn, enables the control surface to move.

In an embodiment of the invention, the actuating mechanism comprises a rod located on the body and/or control surface so as to connect the connection element and the transmission element, capable to extend and shorten by the movement of the transmission element within the bearing, thereby allowing the actuators to move in a coaxial manner. The rod extends outward from the connection element, where the two linear actuators meet. When one of the actuators is powered up, it elongates and moves the connection element. With the movement of the connection element, the ball shaped transmission element connected thereto is enabled to move within the bearing. In order for the actuators to be able to move linearly and coaxially, the length of the rod connecting the transmission element and the connection element varies during movement.

In an embodiment of the invention, the actuating mechanism comprises a moving control surface such as an aileron, flap, rudder, slat, elevator. The desired movements of moving control surfaces such as an aileron, flap, rudder, slat, elevator are carried out by the actuating mechanism disclosed with the invention.

In an embodiment of the invention, the actuating mechanism comprises a control unit that controls the movements of the transmission element. There is a control unit provided that controls the variations in the transmission element with respect to center of gravity during flight and/or movement.

In an embodiment of the invention, the actuating mechanism comprises actuators produced from a dielectric elastomeric material, thereby changing shape with the voltage applied thereon. When the actuator is triggered by electrical energy, it elongates to convert electrical energy into mechanical energy, thus allowing the control surfaces to move.

In an embodiment of the invention, the actuating mechanism comprises actuators with planar and/or cylindrical layers, which may be of different thicknesses relative to each other. The number of layers of actuators with planar and/or cylindrical layers may vary depending on the power and/or force values required by the desired movement, the position in which the mechanism is used, the control surface and such parameters.

The actuating mechanism realized to achieve the object of the present invention is shown in the accompanying figures, among which;

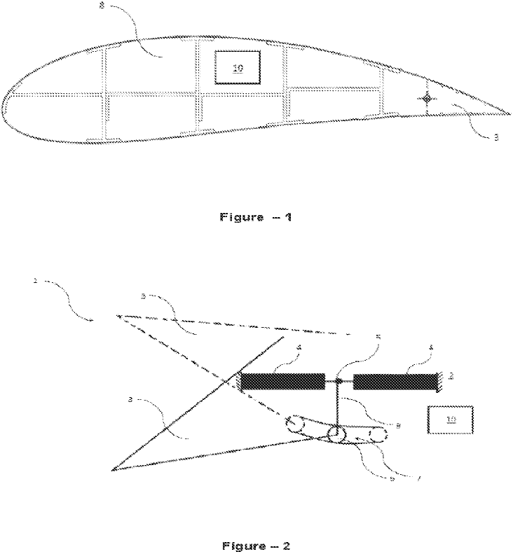

FIG. 1- is a schematic view of the control surface, wing, control unit.

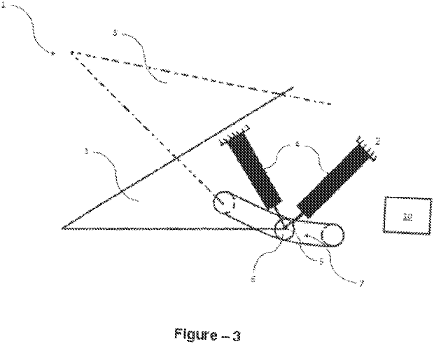

FIG. 2- is a schematic view of a movement mechanism.

FIG. 3- is a schematic view of actuating movement mechanism.

All the parts illustrated in figures are individually assigned a reference numeral and the corresponding terms of these numbers are listed below.
1. Actuating mechanism
2. Body
3. Control surface
4. Actuator
5. Connection element
6. Transmission element
7. Bearing
8. Wing
9. Rod
10. Control unit

The actuating mechanism (1) comprises a body (2) in an air and/or space vehicle, at least one control surface (3) on the body (2), moving relative to the body (2), thereby enabling to control the air flow and the air vehicle to maneuver, at least two actuators (4) produced from an electro-active polymer material between the body (2) and the control surface (3), changing their form depending on electrical energy, thereby triggering the control surface (3).

The actuating mechanism (1) of the invention comprises a connection element (5) between the actuators (4) so as to be able to move depending on the movement of the actuators (4), enabling the actuators (4) to be connected to each other, a transmission element (6) triggered by the connection element (5), thereby allowing the control surface (3) to move, a bearing (7) on the body (2), in which the transmission element (6) is movably located and which has a form that is previously determined by its manufacturer. (FIG. 2) (FIG. 3)

In order to perform the desired movement in air and/or space vehicles, there are control surfaces (3) provided that enable to control the air flow by making a movement relative to the body (2). The control surface (3) is triggered by the actuators (4). The control surface (3) can move with the drive provided by actuators (4) produced from an electro-active polymer material that changes their form depending on electrical energy.

The connection element (5) connects the actuators (4) to each other and is located between the actuators (4). With the movement of the connection element (5), which can move depending on the movement of the actuators (4), the transmission element (6) is actuated, thereby allowing the control surface (3) to move. The transmission element (6) is movably located in a bearing (7) provided on the body (2) in a manufacturer-predetermined fashion.

In an embodiment of the invention, the actuating mechanism (1) comprises at least one wing (8) located on the body (2), extending outward from the body (2), enabling the air and/or space vehicle to rise depending on the air flow, and a control surface (3) located on the wing. (FIG. 1)

In an embodiment of the invention, the actuating mechanism (1) comprises a transmission element (6) in a spherical form. The transmission element (6) may be in the form of a ball sliding and/or rolling in the bearing. Thus, with the movement of the ball shaped transmission element (6), it is aimed that the movement provided by the actuators (4) is transferred to the control surface (3) connected to the ball shaped transmission element (6) so that the control surface (3) realizes the desired movement.

In an embodiment of the invention, the actuating mechanism (1) comprises a bearing (7) with an inclined form. The bearing (7), in which the transmission element (6) can be easily rolled and/or slidably moved, can be rounded, curved, or in a S form, C form, U form.

In an embodiment of the invention, the actuating mechanism (1) comprises actuators (4) connected to the transmission element (6) through the connection element (5) in the bearing (7) and moving along the bearing (7) with the transmission element (6) in the bearing (7). By connecting the actuators (4) directly to the ball shaped transmission element (6) without an intermediary connection, higher force values are obtained compared to other embodiments of the invention. This actuating mechanism (1) can be used in places requiring higher force values depending on the position of the control surface (3) and on the form of the body (2) in the air and/or space vehicle.

In an embodiment of the invention, the actuating mechanism (1) comprises actuators (4) that are connected so as to be linear and coaxial to each other. When one of the linear and coaxial actuators (4) is electrically energized, the electrically energized actuator (4) elongates and accordingly the other actuator (4) shortens itself. The connection element (5) moves depending on the movement of the actuators (4). With the movement of the connection element (5), the transmission element (6) is triggered. With the movement of the transmission element (6), the control surface is enabled to move.

In an embodiment of the invention, the actuating mechanism (1) comprises a rod (9) located on the body (2) and/or control surface (3) so as to connect the connection element (5) and the transmission element (6), capable to elongate and shorten by the movement of the transmission element (6) within the bearing (7), thereby allowing the actuators (4) to move in a coaxial manner. The rod (9) extends outward from the connection element (5) to which the linear actuators (4) are connected. When the actuators (4) are powered up, they change their form and move the connection element (5) that is in between them. With the movement of the connection element (5), the rod (9) connected to it triggers the transmission element (6) and enables it to move within the bearing (7). In order for the actuators (4) to be able to move linearly and coaxially, the length of the rod (9) connecting the transmission element (6) and the connection element (5) must be variable during the movement.

In an embodiment of the present invention, the actuating mechanism (1) comprises a moving control surface (3) such as an aileron, flap, rudder, slat, elevator. The desired movements of the moving control surfaces (3) are carried out by the actuating mechanism (1) disclosed with the invention.

In an embodiment of the invention, the actuating mechanism (1) comprises a control unit (10) controlling the transmission element (6). There is a control unit (10) that controls the variation in the transmission element (6) with respect to center of gravity during flight and/or movement.

In an embodiment of the present invention, the actuating mechanism (1) comprises actuators (4) produced from a dielectric elastomer material. Actuators (4) actuated by electrical energy enable electrical energy to be converted into mechanical energy.

In an embodiment of the invention, the actuating mechanism (1) comprises actuators (4) with planar and/or cylindrical layers, which may be of different thicknesses relative to each other. The number of layers of actuators (4) with planar and/or cylindrical layers may vary depending on the power and/or force values required by the desired movement, the position in which the mechanism is used, the control surface and such parameters.

1. An actuating mechanism (1) configured for an air and/or space vehicle comprising a body (2) and at least one control surface (3) on the body (2), moving relative to the body (2), thereby enabling to control the air flow and the air vehicle to maneuver, the actuating mechanism (1) comprising:
at least two actuators (4) produced from an electro-active polymer material, configured for being located between the body (2) and the control surface (3), changing their form depending on electrical energy, thereby triggering the control surface (3),
a connection element (5) between the actuators (4) so as to be able to move depending on the movement of the actuators (4), enabling the actuators (4) to be connected to each other,
a transmission element (6) in a spherical form, triggered by the connection element (5), thereby allowing the control surface (3) to move,
a bearing (7) on the body (2) in which the transmission element (6) is movably located and which has an inclined form, and
wherein the actuators (4) are connected to the transmission element (6) through the connection element (5) within the bearing (7) and move along the bearing (7) with the transmission element (6) within the bearing (7).

2. An actuating mechanism (1) according to claim 1, comprising a control unit (10) for controlling the movement of the transmission element (6).

3. An actuating mechanism (1) according to claim 1, wherein the actuators (4) have planar and/or cylindrical layers of different thicknesses relative to each other.
